(19) United States
(12) Patent Application Publication
(10) Pub. No.: US 2014/0231645 A1
(43) Pub. Date: Aug. 21, 2014

(54) METHOD AND DEVICE FOR DETECTING ELEMENTARY PARTICLES

(71) Applicant: Erich Griesmayer, Bad Fischau-Brunn (AT)

(72) Inventor: Erich Griesmayer, Bad Fischau-Brunn (AT)

(21) Appl. No.: 14/237,250

(22) PCT Filed: Nov. 15, 2011
(86) PCT No.: PCT/AT2011/000461

§ 371 Date: Feb. 5, 2014

(30) Foreign Application Priority Data
Nov. 17, 2010 (AT) A 1897/2010

(51) Int. Cl. G01T 1/00; G01T 3/00

(52) U.S. Cl. CPC G01T 1/00; G01T 3/00
USPC 250/336.1

(57) ABSTRACT

Provision is made in a method and a device for detecting elementary particles such as for example protons, ions, electrons, neutrons, photons or the like in a detector, wherein a charge pulse is generated in the detector when a particle passes through the detector and every charge pulse is subsequently converted into an electric signal and the signal is indicated and/or recorded in particular after amplification, for individual signals to be amplified in a first, fast amplifier and/or in each case a plurality of signals to be integrated in a second, slow amplifier, as a result of which it becomes possible for individual particles to be detected and in particular at increased signal or count rates for an integration thereof to be provided.

This is a national stage of PCT/AT2011/000461 filed Nov. 15, 2011 and published in German, which has a priority of Austria, no. A 1897/2010 filed Nov. 17, 2010, hereby incorporated by reference.

### FIELD OF THE INVENTION

The present invention relates to a method for detecting elementary particles such as for example protons, ions, electrons, neutrons, photons or the like in a detector, wherein a charge pulse is generated in the detector when a particle passes through the detector and every charge pulse is subsequently converted into an electric signal and the signal is indicated and/or recorded, in particular after amplification, wherein individual signals are amplified in a first, fast amplifier and/or a plurality of signals are each integrated in a second, slow amplifier. The present invention, moreover, relates to a device for detecting elementary particles such as for example protons, ions, electrons, neutrons, photons or the like, including a detector for generating a charge pulse in the detector when a particle passes therethrough, wherein at least one consecutively arranged amplification device for converting every charge pulse into an electric signal and amplifying the same, and optionally a display and/or recording device, are provided, wherein, a first, fast amplifier for amplifying individual signals and a second, slow amplifier for integrating signals are provided.

### PRIOR ART

In order to detect elementary particles such as protons, ions, electrons, neutrons, photons or the like in a detector, a detection or acquisition is usually performed in that an integration of a plurality of signals is performed at high frequencies or signal rates, wherein, upon amplification during such integration, an electric signal is substantially displayed or recorded as a function of the number or plurality of detected particles. The detection of individual particles can usually only be performed at comparatively low frequencies or signal rates while taking into account the options of a resolution of individual pulses or signals, wherein, as opposed to the integration of signals, such embodiments of detectors or detection devices require completely different structures of amplification and evaluation devices arranged to follow the detector. According to the presently known and available methods and devices, it is necessary to know in advance possible frequencies or signal rates in order to perform, in exceptional cases, a detection of individual particles for adaptation to count or signal rates to be expected, or, in particular with high-energy particles, to acquire data substantially averaged, over an extended or large period of time by an integration of the signals. In known methods and devices, it is thus normally not possible by one and the same device to both detect individual particles and their sequences or pulses over time and use an integration of particles when exceeding a count rate or signal rate in order to maintain a result averaged over an extended period of time.

A method and a device of the kind mentioned initially can be taken from WO 2007/010448 A2, for example, wherein for a X-ray detector a counting channel and an integrating channel being separate therefrom are provided for allowing a quantitative evaluation of information with a CT scanner, for example.

Further methods and devices for detecting different radiation and/or elementary particles, sometimes using several, potentially different detectors are known from US 2007/0075251 A1, US 2008/099689 A1, U.S. Pat. No. 3,579,127 A, U.S. Pat. No. 3,805,078 A or WO 97/00456 A1, for example.

### SUMMARY OF THE INVENTION

The invention, therefore, aims to provide a method and device for detecting elementary particles of the initially defined kind, by which the above-mentioned drawbacks of the prior art can be reduced or completely avoided, and, in particular, to provide a method and device which enable both a measurement or detection of individual particles and an integration of count rates, in particular upon exceeding of a given threshold value for signal rates, as a function of such signal rates or desired boundary conditions, without knowing in advance count or signal rates to be expected and allow a reliable detection or evaluation of small-size signals.

To solve these objects, a method of the initially defined kind is essentially characterized in that discharging of a charge pulse or signal from the detector is performed on the low-voltage side. In that both an amplification of individual signals in a fast amplifier and, or alternatively, an integration of each of a plurality of signals in a second, slow amplifier are performed, it has become possible by a joint method, as opposed to the prior art, to provide both the detection or measurement of individual pulses or signals and the integration thereof, in particular where correspondingly high count rates occur, without knowing in advance count or signal rates to be possibly expected. The method according to the invention thus enables the detection of signals or pulses generated by elementary particles irrespectively of a, previous restriction as required in the prior art in respect to a possible detection of individual particles or an integration of the same. When detecting elementary particles, the detection and evaluation of small-size signals is usually required such that a good signal/noise ratio has to be sought. In order to avoid excessive noise, and enable a simpler distinction of such signals having small sizes relative to a base quantity, for instance a base voltage or a base current, it is thus proposed according to the invention that discharging of a charge pulse or signal from the detector is performed on the low voltage side. In that according to the invention discharging of a charge pulse or signal is provided on the low-voltage side of the detector, the distinction from a background, and/or detection, of small-size signals has become much simpler as compared to the prior art, where signals are tapped or detected on the high-voltage side required for operating the detector. The low-voltage-side discharge or wiring provided by the invention will, in particular, prevent a leakage current in a high-voltage cable possibly having a large length from being detected such that, in the main, the precise measuring of the measurement current of a detector will be enabled.

According to a preferred embodiment, it is proposed in this context that, as a function of the rate of the electric signals, individual signals are amplified in the first, fast amplifier and signals are integrated in the second, slow amplifier at least upon exceeding of a threshold value of the rate of the signals. In this manner, the measuring or detecting of individual particles is feasible at low rates or frequencies, in particular as a function of the signal rate actually occurring during measuring, while enabling the integration of each of a plurality of signals from at least a threshold value or limit value.

For a simple and proper subdivision into measurements of individual signals or pulses, or an integration of each of a plurality of detection signal amplifications differing therefrom, it is proposed according to a further preferred embodiment that the signals are separated as a function of the rate by a capacitor preceding at least a first amplifier for amplifying individual low-rate signals, or a high-pass element, and/or by an inductive element preceding at least a second amplifier for amplifying high-rate signals, or a low-pass element. By appropriately selecting the characteristic data or parameters of the elements arranged to precede the individual amplifiers, it has thus become possible, for instance also as a function of different measuring conditions or different elementary particles to be detected, or parameters threreof, to provide, if desired, an adjustment in view of a separate, or optionally also simultaneous, detection of individual signals or pulses as well as an integration of each of a plurality thereof for detecting an averaged value over an extended period of time.

In particular as a function of the individual elements used for amplification and signal processing, it is proposed according to a further preferred embodiment that amplifications in the different amplifiers are performed at overlapping rates of signals. By detecting signals in the different amplifiers at overlapping rates of signals, a check and, if required, a calibration within the overlapping range with a simultaneous detection of individual signals or pulses as well as an integration of each of a plurality thereof have also become possible, while providing a plurality of different parameters or characteristic data of the detected elementary particles.

While electrically charged particles generate appropriate electric signals in a detector, it is proposed according to a further preferred embodiment of the method according to the invention for detecting uncharged particles that the detector material is doped or coated with a converter material for the detection of uncharged particles. By providing such a converter material, electric pulses are generated by an uncharged particle when passing through the detector material because of said converter material, which electric pulses will subsequently serve to detect such an uncharged particle.

In order to detect particles over very wide ranges of possible signal or count rates, or large bandwidths, it is proposed according to a further preferred embodiment that a material enabling fast charge transport at room temperature, e.g. diamond, is used as said detector material. Such detector materials enabling fast charge transports at room temperature, for instance, enable not only the detection of individual particles up to high count or signal rates at a high time resolution, but also the precise and reliable integration of each of a plurality of such pulses or signals. Besides the fastness and insensitiveness to light, the radiation strength of diamond is, for instance, also a selection criterion for such a detector material.

To solve the above-cited objects, a device of the initially defined kind is, moreover, essentially characterized in that the tapping of the charge pulses or signals is provided on the low-voltage side of the detector, in particular with the arrangement of a support capacitor. As already pointed out above, it has thus become possible to provide both the detection of individual pulses or signals and the detection of a value averaged over an extended period of time by integrating each of a plurality of such signals using a joint device and, for instance, without knowing in advance count rates or signal rates to be expected in particular in order to improve the noise/signal ratio, it is proposed according to the invention that the tapping of the charge pulses or signals is provided on the low-voltage side of the detector, in particular with the arrangement of a support capacitor. As already pointed out above, the detection of an interfering leakage current in a high-voltage cable possibly having a large length can be prevented by tapping the charge pulses or signals on the low-voltage-side. Due to the support capacitor preferably provided by the invention, the discharge of the detector can be rapidly compensated for by the support capacitor, in particular at high beam rates, whereby it is, in particular, possible to keep the detector voltage at normal voltage and maintain the functionality of the detector even at high ionization rates. In this respect, it is essential that the wiring of a support capacitor will only be enabled if the charge pulses or signals are tapped on the low-voltage side as is preferably provided by the invention.

In this respect, it is proposed according to a preferred embodiment that the second, slow amplifier is provided for integrating signals upon exceeding of a threshold value of the rate of said signals.

For a reliable and simple separation during the detection of signals of elementary particles when performing a measurement of individual pulses or signals, and/or an integration of each of a plurality thereof, it is proposed according to a further preferred embodiment that, for separating the signals as a function of the rate, at least one amplification element for amplifying low-rate signals is preceded by a capacitor for blocking high-frequency signals, or a high-pass filter, and/or at least one amplifier for amplifying high-rate signals is preceded by an inductive element, or a low-pass filter, for blocking low-rate signals. As already pointed out above, it has become possible, by selecting or adjusting the parameters of the individual elements of the amplifier, or the elements preceding the same, to appropriately adjust the measuring ranges for measuring individual particles, or each integrating the same, optionally by taking into account measuring conditions and/or measuring parameters.

For instance for calibrating the different measuring methods possible in the device according to the invention within a signal or count rate range in which both a measurement and detection of individual particles or pulses and an integration of the same is possible, it is, moreover, proposed that the capacity of the capacitor and/or the inductance of the inductive element or the properties of the low-pass filter are selected for separating signals at overlapping rates, as in correspondence with a further preferred embodiment of the device according to the invention.

While, as already mentioned above, the detection of charged Particles is substantially directly enabled as the latter Pass through the detector by generating electric pulses or signals, it is proposed according to a further preferred embodiment for detecting uncharged particles that the detector material is provided with an implanted converter material or at least a coating comprising a converter material for the detection of uncharged particles.

In particular when taking into account the possibly high count rates or signal rates encountered in the detection of elementary particles, it is proposed according to a further preferred embodiment that a material enabling fast charge transport at room temperature, e.g. diamond, is provided as said detector material.

To solve the above-cited objects, the invention, moreover, proposes the use of a method according to the invention or a preferred embodiment thereof, or a device according to the invention or a preferred embodiment thereof, for detecting particles in particle accelerators, in reactor installations, in diagnostic devices such as X-ray devices, CT devices or the like.

### SHORT DESCRIPTION OF THE DRAWINGS

In the following, the invention will be explained in more detail by way of exemplary embodiments schematically illustrated in the drawing, Therein:

FIG. 1 is a schematic wiring diagram of a device according to the invention for carrying out the method of the invention for detecting elementary particles;

FIG. 2 is a schematic illustration of a detector to be used in a device according to the invention for carrying out the method of the invention, substantially in consideration of the flow chart according to FIG. 1, FIG. 2a depicting a schematic top view of such a detector, including an energy supply and a signal discharge, and FIG. 2b illustrating a section along line II of FIG. 2a;

FIG. 3 is a schematic wiring diagram of a first embodiment a first amplifier and a second amplifier disposed downstream of the detector;

FIG. 4 in an illustration similar to that of FIG. 3 depicts a modified embodiment of a first amplifier disposed downstream of the detector, of a device according to the invention for carrying out the method of the invention;

FIG. 5 is a schematic illustration of different measuring ranges when measuring individual particles and integrating a plurality of measurements;

FIG. 6 schematically illustrates different measurements, FIG. 6a illustrating the measurement or detection of individual signals or pulses, and FIG. 6b depicting the integration of each of a plurality of signals or pulses;

FIG. 7 is a schematic illustration of a detector doped with a converter material, with a coating being provided on the surface of the detector material in the embodiment according to FIG. 7a, and a converter material being partially integrated or doped into the interior of the detector material in the embodiment according to FIG. 7b;

FIG. 8 is a further schematic wiring diagram of a device according to the invention for carrying out the method of the invention for detecting elementary particles, which substantially represents a combination of the illustrations according to FIG. 1 and FIG. 3; and

FIG. 9 in an illustration similar to that of FIG. 2b depicts a section through a modified embodiment of a detector of a device according to the invention.

### DETAILED DESCRIPTION OF PREFERRED EMBODIMENTS

In FIG. 1, a detector, e.g. a diamond detector, which is supplied via high voltage HV is schematically denoted by 1, wherein a charging resistor R3 and a charging capacity C3 connected to ground via a grounding wire 2 are indicated. Tapping of the signals of the detector 1 is performed on the low-voltage side of the latter via a discharge or signal line 3.

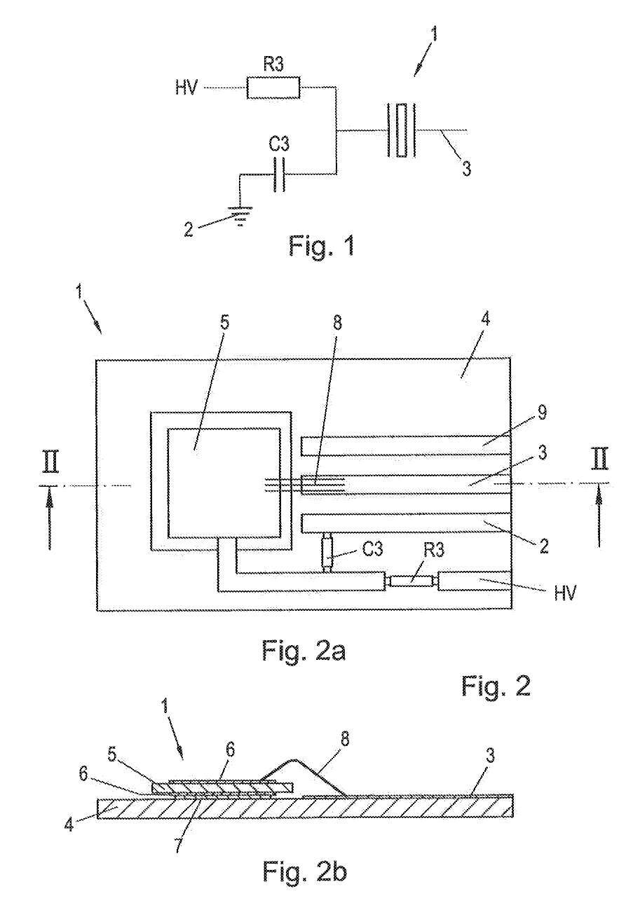

In FIG. 2, a supporting plate 4 is schematically indicated, to which a detector element comprising, for instance, a diamond substrate 5 is mounted, wherein contactings of the detector are indicated by 6 in FIG. 2b.

The fixation of the substrate 5 and a contact 6 to the supporting plate 4 is realized by an adhesive 7.

In addition, a contact connection to the signal line, which is again denoted by 3, is indicated via bonding wires 8 in FIGS. 2a and 2b.

The supply of the detector 1 is realized similarly as in the embodiment according to FIG. 1, via a high-voltage supply HV, wherein a charging resistor is again indicated by R3 and a charging capacity is again indicated by C3, the charging capacity C3 being again connected to earth via a grounding wire 2.

A further grounding wire provided on the low-voltage side is denoted by 9 in FIG. 2a.

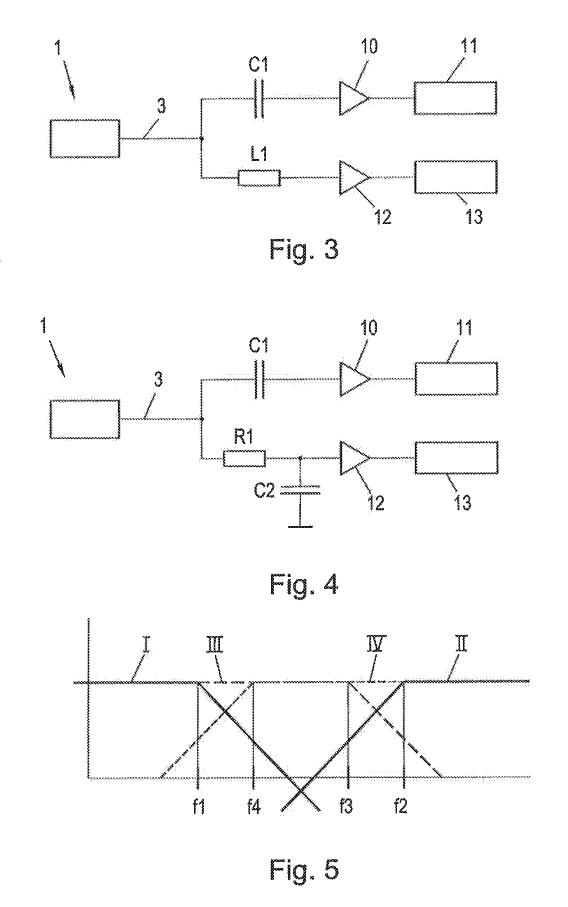

A signal emitted from the detector 1 reaches an amplification and evaluation unit via signal line 3 as shown in FIG. 3, wherein, as a function of the frequency or count and/or signal rate as will be discussed in more detail below, an amplification is performed in a first, fast preamplifier 10 and an evaluation is subsequently made in an evaluation unit 11, such an AC path enabling the detection and processing of individual particles.

The first, fast amplifier 10 is preceded by a capacitor C1 so as to ensure, by suitable parameters of the capacitor C1, that signals will no longer reach the amplifier 10 and the evaluation unit 11, for instance upon exceeding of a threshold value.

In the same manner, the signal line 3 is coupled to a second, slow amplifier 12, to which signals are fed by the signal line 3 via an inductance L1, wherein an evaluation unit 13 of the signals to be integrated is provided downstream of the second, slow amplifier 12 in a so-called DC path. Similarly, it will be ensured by selecting suitable parameters of the inductance or inductive element L1 that an amplification by an integration of each of a plurality of signals in the DC path will only be enabled if the number of signals has exceeded a given threshold value.

FIG. 4 depicts a modified embodiment, wherein the first, fast amplifier 10 is again preceded by a capacitor C1 similarly as in the embodiment according to FIG. 3.

In the modified embodiment according to FIG. 4, the amplifier 12 and the evaluation unit 13 are preceded by a low-pass element comprised of a resistor R1 of a capacity, or a capacitor C2, instead of the inductive element provided in FIG. 3.

The fast, first amplifier 10 may be preceded by a high-pass element instead of the capacitor C1 preceding the fast, first amplifier 10, similarly to the low-pass element comprised of elements R1 and C2.

Also in the embodiment according to FIG. 4, splitting or partitioning of the signals fed via the signal line 3 is effected into an AC path formed by elements 10 and 11 for detecting and evaluating individual pulses or signals and a DC path formed by elements 12 and 13 for integrating each of a plurality of signals or pulses.

In FIG. 5, it is schematically illustrated how either a separation or subdivision into substantially different measuring ranges or different pulse or signal rate ranges, or a respective overlap, can be achieved by the appropriate selection of the elements preceding the amplifiers 10 and 12, respectively, with both a detection of individual particles and, at the same time, an integration of each of a plurality, of signals being feasible in the overlapping range.

In the schematic diagram according to FIG. 5, full lines I and II are each indicated in a frequency or rate range, wherein the measuring of individual signals according to the AC path formed by elements 10 and 11 is performed up to a limiting frequency f1, with the sensitiveness for detecting individual signals decreasing subsequently.

The detection of signals each by integrating a plurality thereof according to the DC path formed by elements 12 and 13 is substantially made starting from a frequency or rate f2 according to full line II. With such a selection of the parameters for the elements preceding the amplifiers 10 and 12, substantially no detection of signals will thus occur in a subrange lying therebetween.

According to broken lines III, and IV, it is, on the other hand, provided that the detection of individual signals takes place up to a frequency f3, while an integration of signals is already effected from a frequency or rate f4, which is lower than the frequency or rate f3, so that in the overlapping range between rates f4 and f3 a detection and evaluation both according to the AC path using elements 10 and 11 and according to the DC path using elements 12 and 13 are performed.

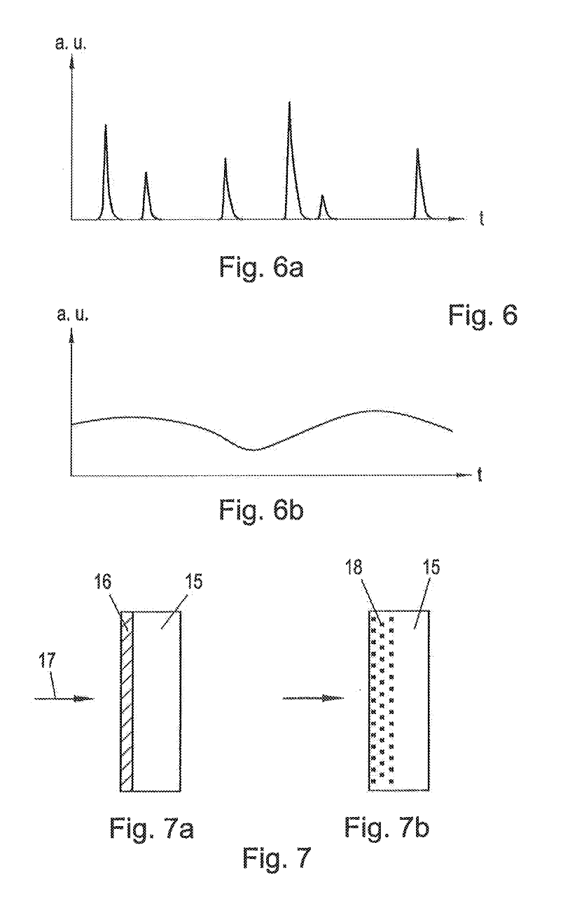

FIGS. 6a and 6b schematically illustrate results or wave forms obtainable both by a measurement of individual particles and by integration, an arbitrary unit (a.u.) being each indicated on the ordinate for a measured quantity.

From FIG. 6a, the detection of individual pulses or signals is clearly apparent, which can each be generated and detected by an individual particle as the latter passes through the detector 1 or impinges on the same, while the illustration according to FIG. 6b substantially depicts an average over an extended period of time each by detecting and integrating several signals or pulses.

While during the detection of electrically charged particles, the latter trigger or cause electric signals immediately upon entry into or passage through a detector, which electric signals can subsequently be detected and evaluated in the manner described above, it is provided for the detection of uncharged particles that a detector material, which is denoted by 15 in FIG. 7, is coated with a converter material 16 on one of its surfaces, the direction of an impinging particle or particle flow being indicated by arrow 17.

Instead of the coating illustrated in FIG. 7a with a converter material, such a converter material 18 can also be implanted into the detector material 15, or the detector material 15 can be doped with the same, as is indicated in FIG. 7b.

In particular as a function of the particles or signals to he determined or detected, it is, moreover, also possible to provide, for instance, a layered structure each comprising layers of a converter material alternating with layers of a detector material.

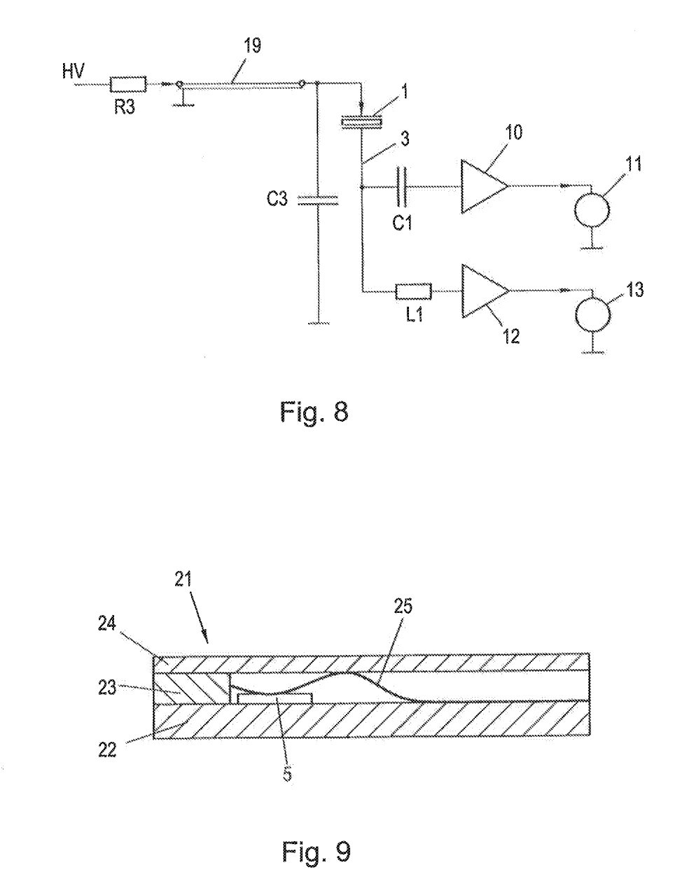

FIG. 8 is an illustration of a modified embodiment, said illustration substantially combining the illustrations according to FIGS. 1 and 3 such that the reference numerals of said preceding Figures have been retained for identical elements.

From FIG. 8, it is apparent that tapping of the signals is again effected on the low-voltage side by a detector schematically denoted by 1 via a signal line 3, wherein, as in the preceding embodiments, amplification, in a first, fast amplifier 10 according to the frequency or count and/or signal rate and subsequently in an evaluation unit 11 according to an AC path are performed for detecting individual particles.

The signal line 3 is again coupled via an inductance L1 to a second, slow amplifier 12 and an evaluation unit 13 of the signals to be integrated in the so-called DC path.

From FIG. 8, the support capacitor C3 is clearly apparent, which has an essential task, in particular at high beam rates. The detector 1 is in each case discharged by ionization, discharging of the detector 1 causing the voltage on the detector 1 to break down and hence the functionality of the detector 1 to be lost. Such discharging is rapidly compensated for by the support capacitor C3, with the detector voltage remaining at nominal voltage and, the functionality of the detector I thus being preserved even at high radiation or ionization rates. Such a wiring or arrangement of a support capacitor C3 is possible with a low-side wiring or a low-voltage-side tap of the signals, as is clearly apparent from FIG. 8.

A cable 19 possibly having an extremely large length is additionally indicated in FIG. 8 on the high-voltage side HV. Such a cable may lead to a high leakage current, and hence an error source in the detection of the measurement current of the detector, any influence of such a leakage current being again prevented by the low-voltage-side wiring of the measuring electronics, as is clearly apparent from FIG. 8.

FIG. 9 depicts a modified embodiment of a contact connection of a detector denoted by 21. In said detector 21, a detector element, which is again denoted by 5 and, for instance, comprised of diamond, is disposed on a base plate 22, wherein an intermediate plate 23 and a cover plate 24 are, moreover, indicated in FIG. 9.

In this embodiment, contacting of the detector element 5 is realized by spring elements 25 formed, for instance, by gold-plated beryllium springs. In this case, a contact pressure is applied purely mechanically by the clamping of the spring elements 25, while, for instance, in the embodiment illustrated in FIG. 2b contacting is provided by gluing and/or bonding.

The suitable selection of the dimensions between the individual plate-shaped elements 22, 23 and 24 ensures the safe clamping, and hence reliable contacting, of the spring-shaped contact element 25 while simultaneously protecting the detector material.

In order to optimize the read-out performance of the detector 1 or 21, respectively, the former is, for instance, optimized to a wave resistance of 50 ohms. This will result in the optimum adaptation to the input impedance of a preamplifier of likewise 50 ohms, and to the wave resistance of a 50-ohm-cable optionally provided between the detector and the preamplifier.

As a function of the elementary particles to be detected, it may be provided that packets of such particles each comprising more than a single particle are detected. Such packets, which, for instance in a particle accelerator, may comprise an extremely small distance of, e.g., less than 100 ns, in particular about 25 to 50 ns, can each be detected as a packet, wherein pulse heights will, in particular, be summed up in order to enable a statement or assessment as to the overall particle rate.

By enabling both the measurement or detection of individual particles in the processing or treatment of the signals derived from the detector over the AC path formed by elements 10 and 11 and the detection of each of a plurality of particles by an integration of the same, in particular at high rates or frequencies, it has thus become possible to provide an appropriate detection of elementary particles without knowing in advance signal rates to be expected.

Such a detection of elementary particles, for instance, is of special interest in the context of scientific examinations, e.g. in particle accelerators or particle detectors. The option of both detecting individual particles or pulses or signals and integrating the same can, for instance, also be used for measuring the intensity in particle accelerators or similar installations, both for supervision and, for instance, for detecting the actual formation of a particle beam.

In addition, such a detection of individual signals or particles and the substantially simultaneous integration thereof can, for instance, be used in the field of medical technology both for diagnosing and, for instance, for imaging processes, whereby monitoring to avoid overdosing has also become possible.

Similarly, the substantially simultaneous detection and integration of individual particles can also be used in electrical power engineering applications, e.g., in the context of the development of reactors.

1. A method for detecting elementary particles such as for example protons, ions, electrons, neutrons, photons or the like in a detector, wherein a charge pulse is generated in the detector when a particle passes through the detector and every charge pulse is subsequently converted into an electric signal and the signal is indicated and/or recorded, in particular after amplification, wherein individual signals are amplified in a first, fast amplifier and/or a plurality of signals are each integrated in a second, slow amplifier, wherein discharging of a charge pulse or signal from the detector is performed on the low-voltage side.

2. The method according to claim 1, wherein, as a function of the rate of the electric signals, individual signals are amplified in the first, fast amplifier and signals are integrated in the second, slow amplifier at least upon exceeding of a threshold value of the rate of the signals.

3. The method according to claim 1, wherein the signals are separated as a function of the rate by a capacitor preceding at least a first amplifier for amplifying individual low-rate signals, or a high-pass element, and/or by an inductive element preceding at least a second amplifier for amplifying high-rate signals, or a low-pass element.

4. The method according to claim 1, wherein amplifications in the different amplifiers are performed at overlapping rates of signals.

5. The method according to claim 1, wherein the detector material is doped or coated with a converter material for the detection of uncharged particles.

6. The method according to claim 1, wherein a material enabling fast charge transport at room temperature, e.g. diamond, is used as said detector material.

7. A device for detecting elementary particles such as for example protons, ions, electrons, neutrons, photons or the like, including a detector for generating a charge pulse in the detector when a particle passes therethrough, wherein at least one consecutively arranged amplification device for converting every charge pulse into an electric signal and amplifying the same, and optionally a display and/or recording device, are provided, wherein a first, fast amplifier for amplifying individual signals and a second, slow amplifier for integrating signals are provided, wherein the tapping of the charge pulses or signals is provided on the low-voltage side of the detector, in particular with the arrangement of a support capacitor.

8. The device according to claim 7, wherein the second, slow amplifier is provided for integrating signals upon exceeding of a threshold value of the rate of the signals.

9. The device according to claim 7, wherein, for the separation of the signals as a function of the rate, at least one amplification element for amplifying low-rate signals is preceded by a capacitor for blocking high-frequency signals, or a high-pass filter, and/or at least one amplifier for amplifying high-rate signals is preceded by an inductive element, or a low-pass filter, for blocking low-rate signals.

10. The device according to claim 9, wherein the capacity of the capacitor and/or the inductance of the inductive element, or the properties of the low-pass filter are selected for the separation of signals at overlapping rates.

11. The device according to claim 7, wherein the detector material is provided with an implanted converter material or at least a coating comprising a converter material for the detection of uncharged particles.

12. The device according to claim 7, characterized in that a material enabling fast charge transport at room temperature, e.g. diamond, is provided as said detector material.

13. The use of a method according to claim 1, for detecting particles in particle accelerators, in reactor installations, in diagnostic devices such as X-ray devices, CT devices or the like.

14. (canceled)

15. (canceled)

16. The use of a device according to claim 7, for detecting particles in particle accelerators, in reactor installations, in diagnostic devices such as X-ray devices, CT devices or the like.
